(19) United States
(12) Patent Application Publication
(10) Pub. No.: US 2017/0261344 A1
(43) Pub. Date: Sep. 14, 2017

(54) HALL EFFECT LINEAR POSITION SENSOR FOR MOTOR VEHICLE

(71) Applicant: Valeo Systemes de Controle Moteur, Cergy Saint Christophe (FR)

(72) Inventors: Vincent Guibet, Vaucelles (FR); Thierry Boucher, Cabourg (FR); Diego Rossi, Pianfei (cn) Italie (IT)

(73) Assignee: Valeo Systemes de Controle Moteur, Cergy Saint Christophe (FR)

(21) Appl. No.: 15/506,265

(22) PCT Filed: Aug. 24, 2015
(86) PCT No.: PCT/FR2015/052257

§ 371 Date: May 24, 2017

(30) Foreign Application Priority Data
Aug. 25, 2014 (FR) 1457967

(51) Int. Cl. G01D 5/14

(52) U.S. Cl. CPC G01D 5/145; F16D 25/00

(57) ABSTRACT

The invention concerns a Hall effect linear position sensor for a motor vehicle, in particular for a clutch master cylinder for a motor vehicle, comprising a piston (20) movable in translation in relation to a fixed part of the position sensor, either the piston (20) or the fixed part comprising a magnet (22) with diametrical magnetization received in a housing (24), and either the piston (20) or the fixed part comprising a magnetic field detection circuit, the magnet (22) and the housing (24) being shaped so as to enable the insertion of the magnet (22) in the housing (24) only in the angular positions of the magnet in which, when the magnet (22) is axially level with the detection circuit, the direction of the magnet (22) at the detection circuit is substantially parallel to the direction of the field lines in the magnet (22).

This invention concerns a Hall effect linear position sensor for a motor vehicle, and an actuator for a motor vehicle, comprising such a linear position sensor. The invention envisages in particular a clutch operating device or “clutch master cylinder” for a motor vehicle comprising such a Hall effect linear position sensor.

In a known way, a clutch master cylinder allows the disengagement and engagement of the clutch in a motor vehicle with a manual gearbox to be hydraulically operated. More precisely, such a clutch master cylinder is conventionally installed at the input of a hydraulic clutch operation circuit, as described for example in patent application FR-A-2 862 114 in the name of VALEO EMBRAYAGES. The master cylinder is mechanically connected to the clutch pedal, operated by the driver of the motor vehicle, by means of a rod. The rod is integral with a piston moving in translation in a hollow body of a clutch master cylinder, delimiting therein a hydraulic chamber of variable volume. The piston is provided to expel an operating fluid or liquid contained in the hydraulic chamber towards the output of the hydraulic operating circuit formed by a receiving cylinder substantially identical to the master cylinder.

Thus, the position of the piston in the hydraulic chamber of the clutch master cylinder allows the engaged or disengaged status of the clutch to be determined. This information can in particular be used by the cruise control of the motor vehicle, the automatic so-called “stop and start” system of the internal combustion engine when the vehicle is stationary or even by an electric parking brake.

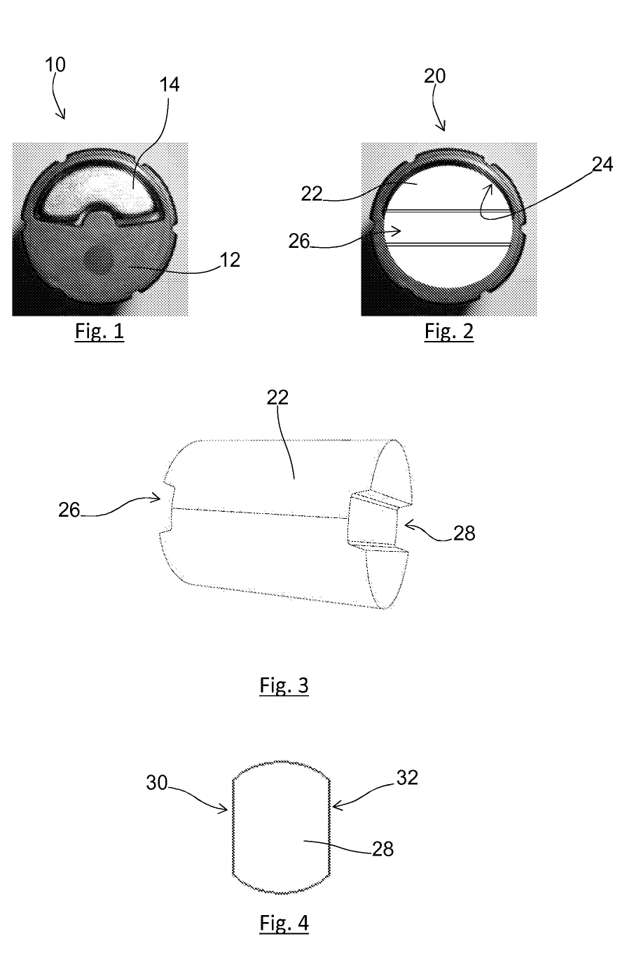

In order to know the position of the clutch master cylinder, it is known to equip the piston 10 with a magnet 12, as shown in FIG. 1, particularly by over-molding the piston 10 onto the magnet 12. In this case, the hollow body includes an integrated magnetic field detection circuit, thus forming a Hall effect linear position sensor with the magnet 12 in the piston 10.

Here, the magnet 12 has a cylindrical form with a cross-section in the form of a ring portion, whereas the piston 10 is cylindrical with a circular cross-section. The magnet has an axial direction of magnetization, in other words, the field lines are substantially parallel to the main extension direction of the piston and the magnet 12, perpendicular to the plane of FIG. 1, which also corresponds to the direction of movement of the piston 10.

The magnet 12 is made of rare earth, in particular based on Neodymium, Dysprosium or Samarium. These materials offer very good magnetic performance, particularly retentivity, which allows a very effective Hall effect sensor to be made. However, the cost of these rare earth-based materials is very high.

The aim of the invention is to propose an improved Hall effect linear position sensor.

To this end, the invention proposes a Hall effect linear position sensor for a motor vehicle, in particular for the actuator for a motor vehicle, in particular for a clutch master cylinder for a motor vehicle, comprising a piston movable in translation in relation to a fixed part of the position sensor, either the piston or the fixed part comprising a magnet with diametrical magnetization received in a housing, and either the piston or the fixed part comprising a magnetic field detection circuit, the magnet and the housing being shaped so as to enable the insertion of the magnet in the housing only in the angular positions of the magnet in which, when the magnet is axially level with the detection circuit, the direction of the magnet at the detection circuit is substantially parallel to the direction of the field lines in the magnet.

Thus, the invention proposes to implement a magnet with diametrical magnetization. Furthermore, the magnet and the housing are shaped so as to enable the insertion of the magnet in the housing, only in the angular positions of the magnet allowing the magnet and the detection circuit to be aligned in a direction that is substantially parallel to the field lines in the magnet. This allows the intensity of the magnetic field captured by the detection circuit to be optimized and thus reduces the sensor's sensitivity to noise.

Most preferably, the sensor according to the invention has one or more of the following characteristics, taken individually or in combination:

the magnet has a cylindrical form, preferably with one or two symmetrical flat surfaces;

the magnet is in the form of a bar, preferably with a convex cross-section;

the magnet comprises, on one lateral end, either a groove or a rib, of complementary shape with either a groove or a rib, made at the bottom of the housing;

the magnet comprises on each of its lateral ends either a groove or a rib, of complementary shape with either a groove or a rib, made at the bottom of the housing;

the groove(s) and/or rib(s) have a trapezoidal cross-section;

the groove or grooves on the magnet are oriented in a direction perpendicular to the direction of magnetization of the magnet;

the piston comprises the magnet and the housing receiving the magnet;

the magnet is made of ferrite or a rare earth-based material;

the magnet is covered with a layer of coating, in particular a layer of paint.

The invention also concerns an actuator for a motor vehicle, in particular a clutch master cylinder, comprising a mechanism for the translational control of a movable part of the actuator in relation to a frame of the actuator and a sensor according to the invention of which the piston is integral or combined with the frame of the actuator.

FIG. 1 is a front view of a first example of a piston of a clutch master cylinder of a motor vehicle.

FIG. 2 is a front view of a second example of a piston of a clutch master cylinder of a motor vehicle.

FIG. 3 is a perspective view of the magnet received in the piston shown in FIG. 2.

FIG. 4 is a schematic sectional view of another example of a magnet that can be received in a piston of a clutch master cylinder of a motor vehicle.

An actuator is here deemed to be any device, such as a ram for example, that allows the flow rate or pressure of a fluid to be regulated in order to control another system when particular conditions prevail. A clutch master cylinder is an example of such an actuator that makes it possible, when the driver of the motor vehicle actuates the clutch pedal, to affect a fluid pressure variation in a clutch-receiving cylinder controlling the clutch of the motor vehicle.

A linear position sensor is here deemed to be a sensor allowing the detection of a relative variation in the position of a so-called movable element in relation to another so-called fixed reference element, in a straight direction. In particular, such a sensor allows the detection of a relative translation of the movable element in relation to the fixed element.

A Hall effect sensor is here deemed to be a sensor based on the physical principle of magnetism and in particular comprising a magnetic field source and a magnetic field detector, the magnetic field emitted by the source and detected by the detector varying, here, depending on a relative axial position between the source and the receiver.

Furthermore, the direction of magnetization of a magnet is here deemed to be the main or mean direction of the magnetic field lines in the magnet.

Lastly, the axial direction is here deemed to be the direction of the translational movement of the piston that preferably corresponds to the piston's main extension direction. In particular, when the piston is cylindrical, the axial direction corresponds to the direction of the piston's main axis.

The invention relates to a Hall effect linear position sensor for a motor vehicle, notably for the actuator for a motor vehicle, in particular for a clutch master cylinder of a motor vehicle. The Hall effect linear position sensor comprises a piston movable in translation along an axis in relation to a fixed part of the position sensor.

The movable piston 20, as shown in FIG. 2, comprises a magnet 22 received in a housing 24 with a complementary cross-section.

The fixed part of the sensor comprises a magnetic field detection circuit, allowing the magnetic field emitted by the magnet 22 in the piston 20 to be detected. The magnetic field detected by this detection circuit varies depending on the position of the piston 20 in relation to the fixed part of the sensor.

The magnet 22 here has a cylindrical form. The magnet 22 has diametrical magnetization, meaning that the magnetic field lines in the magnet extend around a diameter of the cross-section of the magnet.

The magnet 22 here is made of anisotropic ferrite, which reduces its cost compared to a rare earth magnet. As a variation, however, the magnet is made of rare earth.

The magnet 22 is preferably made by dry or wet compression, dry compression being preferred because it is cheaper.

As shown in FIG. 2, the magnet 22 and the housing 24 have a circular cross-section. However, the magnet 22 has grooves 26, 28 in its lateral ends. The housing 24 has a complementary rib in the bottom, allowing the magnet 22 to be positioned in the housing 24 in two distinct angular positions only, these two angular positions being symmetrical.

In these angular positions, when the magnet 20 is axially level with the detection circuit in the sensor, the direction from the magnet 20 towards the detection circuit is parallel to the direction of the field lines in the magnet 25. The diametrical magnetization of the magnet, combined with the appropriate angular position of the magnet in the housing and so with respect to the detection circuit in the sensor and with respect to the magnetic field lines in the magnet, gives a higher induction level at the detection circuit than axial magnetization. The sensor thus has lower sensitivity to noise. The sensor's reading path is thus widened. The sensor's output signal is also more linear.

Clearly, the magnet 22 may have a groove only on one lateral end. The presence of a groove on each of its two lateral surfaces enables interchangeable positioning in both directions of insertion of the magnet 22 in the housing 24.

The grooves 26, 28 and the rib in the housing here have a trapezoidal cross-section. This allows the rib to be easily inserted into the groove and thus block the relative rotation of the magnet in relation to the housing. Clearly, other forms of grooves and rib can be envisaged.

The grooves 26, 28 can be made by machining, particularly when the magnet is made of rare earth, after compressing the magnet.

However, the grooves 26, 28 in the magnet 22 are preferably made by means of the compression tool used to form the magnet 22. Thus, the formation of the grooves 26, 28 requires no machining operation. This limits the number of steps of the process adopted to obtain the magnet 22.

The grooves 26, 28 are preferably oriented in a direction perpendicular to the direction of the field lines in the magnet, so as to preserve a maximum of material as close as possible the detection circuit.

The magnet 22 can be covered in a coating to prevent particles or splinters detaching from the magnet, particularly when the grooves are made by machining. In particular, the magnet can be covered with a coat of paint.

FIG. 4 shows another example of a magnet. The magnet 22 in FIG. 4 has a cylindrical form with an oblong cross-section. More precisely, the magnet 22 has the form of a cylinder with a circular section with two symmetrical flat surfaces 30, 32. The flat surfaces are preferably parallel to the direction of magnetization in the magnet. In this case, the housing has a complementary cross-section to receive the magnet 22 in two angular positions. The flat surfaces 30, 32 can be made by grinding.

A Hall effect linear position sensor as described can notably be used in an actuator for a motor vehicle, in particular in a clutch master cylinder. The actuator can comprise a mechanism for the translational control of a part of the actuator that is movable in relation to a frame of the actuator and a sensor as described above. The piston is integral or combined with the movable part of the actuator and the fixed part is integral or combined with the frame of the actuator. The translational control mechanism can be of any type.

Such an actuator for a motor vehicle can in particular be a rod-crank system, an EGR (exhaust gas recirculation) valve or a brake pedal sensor. In the case of a clutch master cylinder, the sensor piston is combined with the clutch master cylinder. The piston is designed to be mechanically connected to the clutch pedal of a motor vehicle. The piston is moved in a hollow body of the clutch master cylinder, forming a control-fluid chamber delimited by the piston. The hollow body receives the magnetic field detector circuit. Thus, the driver's action on the clutch pedal operates a translation of the piston that can be measured by means of the sensor. The translation of the piston causes the control fluid to discharge from the chamber towards a hydraulic circuit that controls the clutch.

The invention is not limited solely to the embodiments described above but can undergo numerous variations.

In particular, the magnet can have a cylindrical form, with any cross-section.

The magnet can also be in the form of a bar, with any cross-section, a convex cross-section being preferred, however, in order to optimize the quantity of magnetizable material of the magnet for a given size of magnet.

Instead and in place of the grooves, the magnet can have ribs, in which case the housing has a groove of a form that is complementary to these ribs.

Lastly, as a variation, the piston may comprise the detection circuit and the fixed part the piston.

1. A hall effect linear position sensor for a clutch master cylinder for a motor vehicle, comprising:
a piston movable in translation in relation to a fixed part of the position sensor,
one of the piston or the fixed part comprising:
a magnet having a cylindrical form with diametrical magnetization received in a housing, and
a magnetic field detection circuit,
the magnet and the housing being shaped so as to enable the insertion of the magnet in the housing only in the angular positions of the magnet in which, when the magnet is axially level with the detection circuit, the direction of the magnet at the detection circuit is substantially parallel to the direction of the field lines in the magnet.

2. The sensor according to claim 1, wherein the magnet has two symmetrical flat surfaces.

3. The sensor according to claim 2, wherein the magnet is in the form of a bar with a convex cross-section.

4. The sensor according to claim 1, wherein the magnet comprises, on one lateral end, either a groove or a rib, of complementary shape with either a groove or a rib disposed at the bottom of the housing.

5. The sensor according to claim 1, wherein the magnet comprises on each of its lateral ends either a groove or a rib, of complementary shape with either a groove or a rib disposed at the bottom of the housing.

6. The sensor according to claim 5, wherein the groove(s) and/or rib(s) have a trapezoidal cross-section.

7. The sensor according to claim 4, wherein the groove on the magnet is oriented in a direction perpendicular to the direction of magnetization of the magnet.

8. The sensor according to claim 1, wherein the piston comprises the magnet and the housing receiving the magnet.

9. The sensor according to claim 1, wherein the magnet is made of ferrite or a rare earth-based material.

10. The sensor according to claim 1, wherein the magnet is coated with a layer paint.

11. An actuator for a clutch master cylinder of a motor vehicle, comprising:
a mechanism for the translational control of a movable part of the actuator in relation to a frame of the actuator; and
a sensor according to claim 1, of which the piston is integral with the movable part of the actuator and the fixed part is integral with the frame of the actuator.
